(19) United States
(12) Patent Application Publication
(10) Pub. No.: US 2026/0270623 A1
(43) Pub. Date: Sep. 10, 2026

(54) Systems and Methods for Calibrating Movement Classification by a Hearing Device

(71) Applicant: SONOVA AG, Staefa (CH)

(72) Inventors: Nadim El Guindi, Bassersdorf (CH); Samuel Elia Johannes Knobel, Zurich (CH); Niklas Ignasiak, Zürich (CH); Nina Stumpf, Maennedorf (CH); Zhongyang Li, Stäfa (CH); Anne-Sofie Micholt, Zuerich (CH); Adam True, Fribourg (CH); Mauro Candela, Cressier (CH); Emily Urry, Zollikon (CH)

(21) Appl. No.: 19/075,322

(22) Filed: Mar. 10, 2025

(51) Int. Cl. H04R 25/00

(52) U.S. Cl. CPC H04R 25/305; H04R 2225/41

(57) ABSTRACT

An exemplary method includes a hearing system detecting an auxiliary device situated on a body of a user of a hearing device, activating, based on the detecting the auxiliary device, a training mode of the hearing device configured to train a model for classifying movement of the user of the hearing device based on first sensor data from a first sensor of the hearing device, and providing, based on second sensor data from a second sensor of the auxiliary device, training input for training the model.

### BACKGROUND INFORMATION

Hearing devices (e.g., hearing aids) are used to improve the hearing capability and/or communication capability of users of the hearing devices. Such hearing devices are configured to process a received input sound signal (e.g., ambient sound) and provide the processed input sound signal to the user (e.g., by way of a receiver (e.g., a speaker) placed in the user's ear canal or at any other suitable location).

Hearing devices may classify movement and/or activity of a user, such as to use different sound processing algorithms based on user activity. However, such movement classification may be difficult, as some activities may present as similar movements to others to the hearing device.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 illustrates an exemplary hearing system that may be implemented according to principles described herein.

FIG. 2 illustrates an exemplary implementation of the hearing system of FIG. 1 according to principles described herein.

FIG. 3 illustrates an exemplary hearing device according to principles described herein.

FIG. 4 illustrates an exemplary hearing device according to principles described herein.

FIG. 5 illustrates an exemplary model according to principles described herein.

FIG. 6 illustrates an exemplary model according to principles described herein.

FIG. 7 illustrates an exemplary method according to principles described herein.

FIG. 8 illustrates an exemplary computing device according to principles described herein.

### DETAILED DESCRIPTION

Systems and methods for improving hearing performance by a hearing device are described herein. As will be described in more detail below, an exemplary system may comprise a memory storing instructions and a processor communicatively coupled to the memory and configured to execute the instructions to perform a process. The process may comprise detecting an auxiliary device situated on a body of a user of a hearing device, activating, based on the detecting the auxiliary device, a training mode of the hearing device configured to train a model for classifying movement of the user of the hearing device based on first sensor data from a first sensor of the hearing device, and providing, based on second sensor data from a second sensor of the auxiliary device, training input for training the model.

By using systems and methods such as those described herein, it may be possible to improve classifying movements of a user of a hearing device, which may be used to select sound processing algorithms specific to the movement, activity, and/or environment. For example, the hearing device may include a model configured to classify movements of the user based on sensor data from a sensor of the hearing device. However, some movements may present similarly to a head-mounted sensor like the sensor in the hearing device, such as walking and nodding. Additional information from an auxiliary device situated on a body of the user may help differentiate between such similar movements.

Systems and methods described herein may utilize auxiliary sensor data from one or more auxiliary devices when such devices are present and such data is available to train the model on the hearing device to improve classification of movement based on the sensor data from the sensor of the hearing device. In this manner, the hearing device may maximize availability of training data for the model so that the model is optimized for application when the auxiliary device is not present. Such improved movement classifications may allow the hearing device to optimally select sound processing algorithms, improving hearing performance for the user. Other benefits of the systems and methods described herein will be made apparent herein.

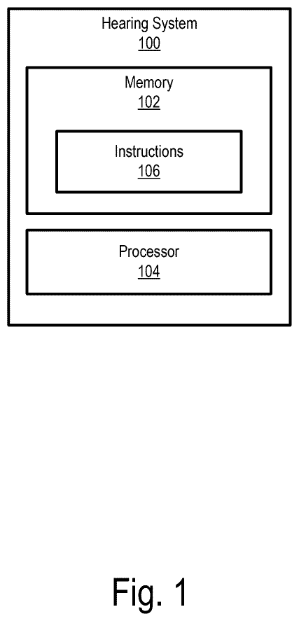

FIG. 1 illustrates an exemplary hearing system 100 (“system 100”) that may be implemented according to principles described herein. As shown, system 100 may include, without limitation, a memory 102 and a processor 104 selectively and communicatively coupled to one another. Memory 102 and processor 104 may each include or be implemented by hardware and/or software components (e.g., processors, memories, communication interfaces, instructions stored in memory for execution by the processors, etc.). In some examples, memory 102 and/or processor 104 may be implemented by any suitable computing device such as described herein. In other examples, memory 102 and/or processor 104 may be distributed between multiple devices and/or multiple locations as may serve a particular implementation. Illustrative implementations of system 100 are described herein.

Memory 102 may maintain (e.g., store) executable data used by processor 104 to perform any of the operations described herein. For example, memory 102 may store instructions 106 that may be executed by processor 104 to perform any of the operations described herein. Instructions 106 may be implemented by any suitable application, software, code, and/or other executable data instance.

Memory 102 may also maintain any data received, generated, managed, used, and/or transmitted by processor 104. Memory 102 may store any other suitable data as may serve a particular implementation. For example, memory 102 may store hearing loss profile data, user preference data, setting data, acoustic parameter data, machine learning data, input sound classification data, hearing performance data, graphical user interface content, movement classification data, model data, sensor data, and/or any other suitable data.

Processor 104 may be configured to perform (e.g., execute instructions 106 stored in memory 102 to perform) various processing operations associated with fitting a hearing device. For example, processor 104 may perform one or more operations described herein to provide, based on sensor data from an auxiliary device, training input for training a model for classifying movement of a user of the hearing device. These and other operations that may be performed by processor 104 are described herein.

As used herein, a “hearing device” may be implemented by any device or combination of devices configured to provide or enhance hearing to a user. For example, a hearing device may be implemented by a hearing aid configured to amplify audio content to a recipient, a sound processor included in a stimulation system configured to apply electrical and acoustic stimulation to a recipient, or any other suitable hearing prosthesis. In some examples, a hearing device may be implemented by a behind-the-ear (“BTE”) housing configured to be worn behind an ear of a user. In some examples, a hearing device may be implemented by an in-the-ear (“ITE”) component configured to at least partially be inserted within an ear canal of a user. In some examples, a hearing device may include a combination of an ITE component, a BTE housing, and/or any other suitable component.

In certain examples, hearing devices such as those described herein may be implemented as part of a binaural hearing system. Such a binaural hearing system may include a first hearing device associated with a first ear of a user and a second hearing device associated with a second ear of a user. In such examples, the hearing devices may each be implemented by any type of hearing device configured to provide or enhance hearing to a user of a binaural hearing system. In some examples, the hearing devices in a binaural system may be of the same type. For example, the hearing devices may each be hearing aid devices. In certain alternative examples, the hearing devices may be of a different type.

In some examples, a hearing device may additionally or alternatively include earbuds, headphones, hearables (e.g., smart headphones), and/or any other suitable device that may be used to facilitate a user perceiving sound in an environment. In such examples, the user may correspond to either a hearing-impaired user or a non-hearing-impaired user.

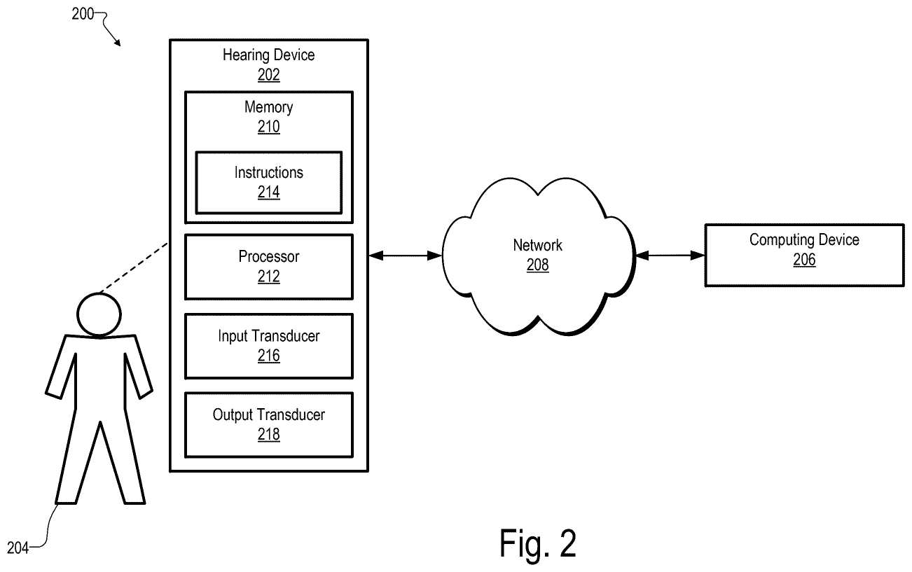

System 100 may be implemented in any suitable manner. For example, system 100 may be implemented by a hearing device and/or a computing device that is communicatively coupled in any suitable manner to the hearing device. To illustrate an example, FIG. 2 shows an exemplary implementation 200 in which system 100 may be provided in certain implementations. As shown in FIG. 2, implementation 200 includes a hearing device 202 that is associated with a user 204 and that is communicatively coupled to a computing device 206 by way of a network 208.

Hearing device 202 may correspond to any suitable type of hearing device such as described herein. Hearing device 202 may include, without limitation, a memory 210 and a processor 212 selectively and communicatively coupled to one another. Memory 210 and processor 212 may each include or be implemented by hardware and/or software components (e.g., processors, memories, communication interfaces, instructions stored in memory for execution by the processors, etc.). In some examples, memory 210 and processor 212 may be housed within or form part of a BTE housing. In some examples, memory 210 and processor 212 may be located separately from a BTE housing (e.g., in an ITE component). In some alternative examples, memory 210 and processor 212 may be distributed between multiple devices (e.g., multiple hearing devices in a binaural hearing system) and/or multiple locations as may serve a particular implementation.

Memory 210 may maintain (e.g., store) executable data used by processor 212 to perform any of the operations associated with hearing device 202. For example, memory 210 may store instructions 214 that may be executed by processor 212 to perform any of the operations associated with hearing device 202 assisting a user in hearing. Instructions 214 may be implemented by any suitable application, software, code, and/or other executable data instance.

Memory 210 may also maintain any data received, generated, managed, used, and/or transmitted by processor 212. For example, memory 210 may maintain any suitable data associated with a hearing loss profile of a user, input sound classifications, sound processing patterns, machine learning algorithms, and/or hearing device function data. Memory 210 may maintain additional or alternative data in other implementations.

Processor 212 is configured to perform any suitable processing operation that may be associated with hearing device 202. For example, when hearing device 202 is implemented by a hearing aid device, such processing operations may include monitoring ambient sound and/or representing sound to user 204 via an in-ear receiver. Processor 212 may be implemented by any suitable combination of hardware and software. In certain examples, processor 212 may correspond to or otherwise include one or more deep neural network (“DNN”) chips configured to perform any suitable machine learning operation such as described herein.

Hearing device 202 may further include an input transducer 216 and an output transducer 218. Hearing device 202 may include additional or alternative components as may serve a particular implementation.

Input transducer 216 may include one or more electroacoustic transducers, e.g., one or more microphones and/or one or more microphone arrays. The one or more microphones may be implemented by one or more suitable audio detection devices configured to detect audio data representative of one or more audio signals presented to a user of hearing device 202. The one or more audio signals may include, for example, audio content (e.g., music, speech, noise, etc.) generated by one or more audio sources included in an environment of the user (e.g., environmental audio/sound). Each microphone may be included in or communicatively coupled to hearing device 202 in any suitable manner.

Additionally or alternatively, input transducer 216 may include a radio frequency (RF) receiver configured to receive RF signals including audio data representative of one or more audio signals presented to the user of hearing device 202. For instance, the RF signals may be received in accordance with a Bluetooth™ protocol and/or by a mobile phone network such as 4G or 5G and/or by any other type of RF communication such as, for example, data communication via an internet connection and/or data communication at a frequency in a GHz range. The audio signal may include, for example, a phone call signal and/or a streaming signal which may be received while delivered from an audio provider, such as a phone call signal provider and/or a streaming media provider and/or may comprise a signal transmitted from a source device, e.g., a smartphone. Each RF receiver may be included in hearing device 202 and/or communicatively coupled to hearing device 202 in any suitable manner.

Output transducer 218 may be implemented by any suitable audio output device, for instance a loudspeaker of a hearing device.

User 204 may be any individual that is a user of a hearing device. Computing device 206 may include or be implemented by any suitable hardware and/or software components (e.g., processors, memories, communication interfaces, instructions stored in memory for execution by the processors, etc.) and may include any combination of computing devices as may serve a particular implementation. In some examples, computing device 206 may be implemented by a mobile phone, a mobile computing device, a tablet computer, a laptop computer, a desktop computer, a server or server system, and/or any other suitable computing device and/or system that may be configured to improve a hearing performance level of the hearing device. In such examples, computing device 206 may be configured to perform any suitable operations such as those described herein to provide training input for training a model to classify movement of user 204.

Network 208 may include, but is not limited to, one or more wireless networks (Wi-Fi networks), wireless communication networks, mobile telephone networks (e.g., cellular telephone networks), mobile phone data networks, broadband networks, narrowband networks, the Internet, local area networks, wide area networks, and any other networks capable of carrying data and/or communications signals between hearing device 202 and computing device 206. In certain examples, network 208 may be implemented by a Bluetooth protocol (e.g., Bluetooth Classic, Bluetooth Low Energy (“LE”), etc.) and/or any other suitable communication protocol to facilitate communications between hearing device 202 and computing device 206. Communications between hearing device 202, computing device 206, and any other device/system may be transported using any one of the above-listed networks, or any combination or sub-combination of the above-listed networks.

System 100 may be implemented by computing device 206 or hearing device 202. Alternatively, system 100 may be distributed across computing device 206 and hearing device 202, or distributed across computing device 206, hearing device 202, and/or any other suitable computing system/device.

Hearing device 202 may be configured to be optimized for user 204 by training a model that is configured to classify movement of user 204 based on sensor data from a sensor of hearing device 202.

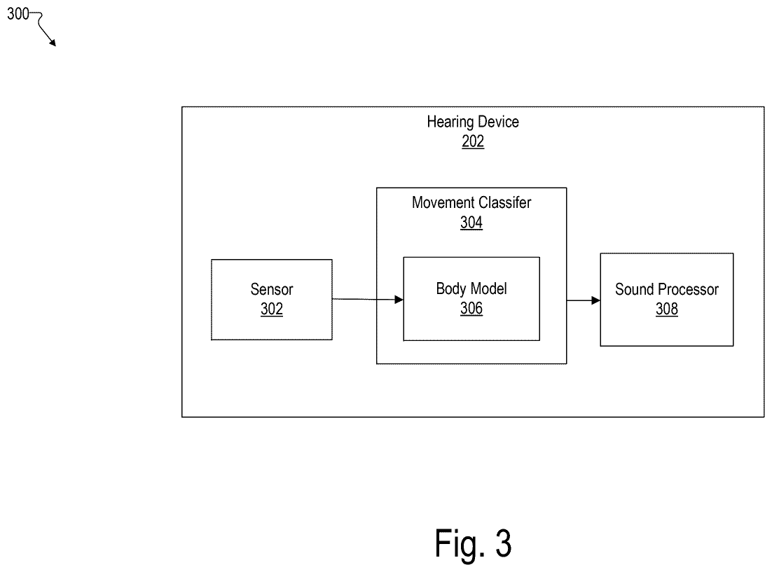

For example, FIG. 3 illustrates an exemplary configuration 300 that shows hearing device 202 that includes a sensor 302, a movement classifier 304 including a body model 306, and a sound processor 308. These components may be in addition to and/or implementations of any of the components shown in FIG. 2 to be included in hearing device 202. While exemplary configuration 300 shows movement classifier 304, body model 306, and sound processor 308 as different components, in some examples, movement classifier 304, body model 306, and/or sound processor 308 may be implemented in a same component or combinations of components and/or modules.

Sensor 302 may be implemented in any suitable manner, including any suitable sensor or sensors that detect movement such as a displacement sensor, e.g., an inertial measurement unit (IMUs), accelerometer and/or gyroscope, for detecting a movement and/or an orientation of the hearing device which may be recorded over time and/or relative to a reference axis such as an axis defined by the gravitational force, such as a triaxial acceleration sensor and/or a 9-axis inertial measurement unit. Such movement may be translated and/or interpreted to correspond to movement of user 204, specifically a head of user 204, as hearing device 202 may be worn on the head of user 204 (e.g., in or behind the ear of user 204).

Movement classifier 304 may be configured to receive sensor data from sensor 302 and analyze the sensor data to interpret the sensor data as movement of hearing device 202 and accordingly, the head of user 204. Further, movement classifier 304 may use body model 306 to extrapolate from the sensor data and/or the movement of the head of user 204 to a movement of the body of user 204 and/or an activity of user 204. For example, sensor 302 may be able to detect an acceleration of hearing device 202 to a particular velocity, which may correspond to hearing device 202 and accordingly user 204 likely being in a moving vehicle. Such a classification of movement (and/or activity) of user 204 may be determined by movement classifier 304 based on sensor data from sensor 302 indicating such an acceleration. As another example, movement classifier 304 may be able to determine from sensor data from sensor 302 that user 204 is likely jumping up and down. In this manner, movement classifier 304 may be configured to determine a movement classification based on sensor data using body model 306.

Sound processor 308 may be implemented by or separate from processor 212 and may be configured to apply various sound processing algorithms to process sound differently based on the different algorithms. Some such sound processing algorithms may be configured to optimize sound processing based on a detected activity and/or movement of user 204. For example, a sound processing algorithm may optimize sound processing for an environment such as a moving car. As another example, a sound processing algorithm may optimize sound processing for user 204 listening to a concert. Sound processing algorithms may optimize for different environments, activities, and/or movements in any suitable manner, such as amplifying different portions of incoming sound differently (e.g., speech vs. noise and/or non-speech, music, audio from a device such as a phone, etc.), beamforming, noise canceling, etc.

However, such sound processing algorithms optimized for specific movements may be found useful when correctly selected and applied, but suboptimal if incorrectly selected. Further, movement classifier 304 may encounter difficulty in classifying some movements that may seem similar to other movements based on sensor data from sensor 302. For instance, from a perspective of sensor 302, user 204 walking and user 204 nodding his or her head may generate sensor data that is similar to one another, with hearing device 202 (and sensor 302) generally moving up and down. However, a sound processing algorithm optimized for user 204 walking and a sound processing algorithm optimized for user 204 in a conversation, which user 204 nodding may indicate (in some examples, in combination with other signals such as speech detected in incoming sound), may process and present sound very differently. For example, a sound processing algorithm optimized for conversation may include beamforming directed at a source of speech and noise canceling for other ambient sound. Conversely, a sound processing algorithm optimized for walking may present or even amplify ambient sound so that user 204 may be aware of his or her surroundings while walking. Thus, a correct determination of movement classification may be important, and may involve subtle differentiation in sensor data from sensor 302.

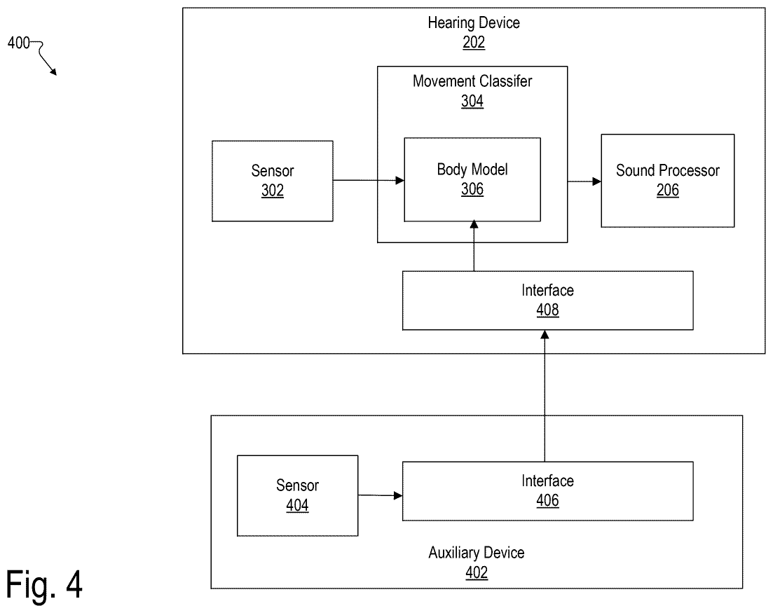

FIG. 4 illustrates an example configuration 400 that shows hearing device 202 configured to use additional sensor data to train body model 306 to calibrate and improve classification of movement of user 204 by movement classifier 304 based on sensor data (e.g., first sensor data) from sensor 302 (e.g., first sensor 302). As shown, configuration 400 includes an auxiliary device 402 that includes an additional sensor (e.g., second sensor 404) and an interface 406. Further, configuration 400 shows hearing device 202 also including an interface 408 to interface with auxiliary device 402 via interface 406.

Auxiliary device 402 may include any suitable device that may be configured to be situated on a body of user 204 and detect movement of the body (or a part of the body) of user 204 via second sensor 404 and communicate sensor data from second sensor 404 to another device. For example, auxiliary device 402 may include a phone, a smartwatch, a fitness tracker, and/or any other such device that user 204 may wear and/or carry on the body and detect movement.

As shown, hearing device 202 may receive second sensor data from second sensor 404 from auxiliary device 402 and utilize the second sensor data to improve classification of movement of user 204. As one example, the second sensor data may provide additional information of the movement of the body of user 204 that hearing device 202 may combine with information about movement of the head of hearing device 202 from sensor 302 to better classify movement of user 204 (e.g., walking versus nodding the head).

Further, hearing device 202 may use the second sensor data to train body model 306 so that body model 306 may be able to better differentiate and classify movement based solely on first sensor data from first sensor 302. For instance, hearing device 202 may detect a presence of auxiliary device 402 and, based on detecting auxiliary device 402, activate a training mode of hearing device 202 configured to train body model 306 using first sensor data from first sensor 302 and the second sensor data from second sensor 404. In this manner, when auxiliary device 402 is removed (or no longer detected), hearing device 202 may continue to classify movement based on first sensor data from first sensor 302 and such classifications may be improved based on the training of body model 306 using data based on the second sensor data from second sensor 404.

Hearing device 202 may detect auxiliary device 402 in any suitable manner, such as a pairing of hearing device 202 and auxiliary device 402 (e.g., via interface 406 and interface 408), an input provided from auxiliary device 402 and/or user 204 to hearing device 202 that auxiliary device 402 is present, etc.

Based on detecting auxiliary device 402, hearing device 202 may activate the training mode that may use both first sensor data from first sensor 302 and the second sensor data from second sensor 404 to train body model 306. Hearing device 202 may utilize the first sensor data and the second sensor data to train body model 306 in any suitable manner. For example, hearing device 202 may provide training input for training body model 306 based on the second sensor data.

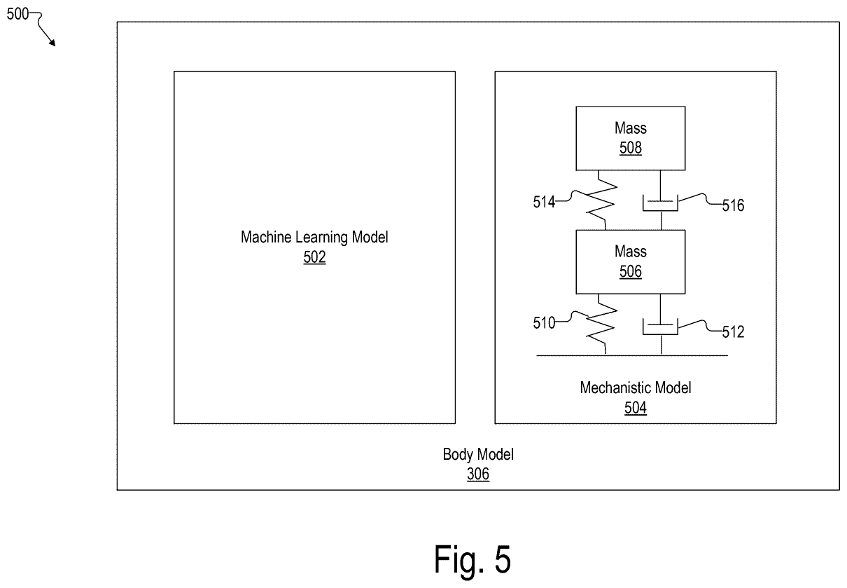

For example, FIG. 5 illustrates an example configuration 500 that shows an example implementation of body model 306. Configuration 500 shows body model 306 including a machine learning model 502 and a mechanistic model 504. While configuration 500 shows body model 306 including both machine learning model 502 and mechanistic model 504, in some examples, body model 306 may include one or the other and/or additional models not shown.

As an example implementation, mechanistic model 504 may include a mass 506 that models the body of user 204 and a mass 508 that models the head of user 204. Mechanistic model 504 models the head and body of user 204 as mass elements (mass 506 and mass 508) that are moveably connected with dampening and limited degrees of freedom. In this example, mechanistic model 504 may include a transfer function between mass 506 and mass 508, but other examples may include more than two mass elements. One such example may include four mass elements for the head, upper torso, lower torso, and shank, but other examples may use additional or fewer mass elements for different parts of the body, with different degrees of freedom.

For configuration 500, mechanistic model 504 (B) may assume a simple spring-mass-damper system, with mass 506 (m₁) connected to the floor by a spring 510 with a stiffness (k₁) and a damper 512 with a damping coefficient (b₁). Mass 508 (m₂) may be connected to mass 506 by a spring 514 with a stiffness (k₂) and a damper 516 with a damping coefficient (b₂). An example transfer function may model the effect of movement of mass 506 on mass 508 as

$$H ( s ) = \frac{{X}_{2} ( s )}{{X}_{1} ( s )} = \frac{{b}_{2} \times s + {k}_{2}}{{m}_{2} \times {s}^{2} + {b}_{2} \times s + {k}_{2}} ,$$

where s is the complex frequency, X₁(s) is the Laplace transform of the m₁ displacement x₁(t), and X₂(s) is the Laplace transform of the m₂ displacement x₂(t).

Using this equation, movement of mass 506 (body) and mass 508 (head) of user 204 may be estimated based on sensor data. For example, A₁ may be local motion of mass 506 and A₂ may be local motion of mass 508. A_{1_tot} may be total (overlaid) motion of mass 506 and A_{2_tot} may be total (overlaid) motion of mass 508. Additional assumptions may include that A_{1_tot} may be represented by the second sensor data (S₁) from second sensor 404 and A_{2_tot} may be represented by the first sensor data (S₂) from first sensor 302. Further, A₁ may be substantially equal to A_{1_tot}, as impact of head movement on body movement may be negligible. Thus, to estimate A₁ and A₂ from B(S₁, S₂) may be simplified to A₂=B(A_{1_tot}, A_{2_tot}).

Therefore, in the training mode, hearing device 202 may provide the first sensor data and the second sensor data to train mechanistic model 504. Further, in some examples, additional information may be included with the second sensor data, such as a labeling (e.g., a ground truth) of movement that provides the classification along with the second sensor data. Such labels may be determined in any suitable manner. For example, hearing device 202 may request, as part of the training mode, user 204 to perform specific movements so that hearing device 202 (and mechanistic model 504) may learn what such movements translate to in terms of the first sensor data and the second sensor data. Additionally or alternatively, a preliminary determination of movement classification may be performed, by hearing device 202 and/or auxiliary device 402 based on the second sensor data (and/or the first sensor data). For instance, auxiliary device 402 may already be classifying movement of user 204 and may provide such classifications to hearing device 202. Additionally or alternatively, user 204 may provide input indicating movement classifications, such as affirming and/or correcting movement classifications and/or providing movement and/or the activity in which user 204 is engaged.

Then, as A₂ is known, parameters of B(b₂, k₂) may be estimated, such as by using a least-mean-squares (LMS) algorithm. In some examples, specific movement patterns may be chosen and optimized to cover relevant movements and provide signals in the first sensor data and the second sensor data for a suitable estimation of the body model parameters. For example, requested and/or detected movement patterns for training may include walking at various speeds, head movements (e.g., nodding, shaking, etc.), and/or combinations of such movements, such as nodding while walking. Head mass (m₂) may be estimated (e.g., using empirical data) based on mass of user 204 (m₁+m₂), which may be known or may be estimated or requested as input from user 204.

Subsequently (and/or concurrently), in an application mode (which may be activated upon deactivation of the training mode, run in conjunction with the training mode, and/or activated by user 204 and/or any other suitable trigger), hearing device 202 may determine, based on first sensor data from first sensor 302, using body model 306, a classification of a movement of user 204.

For example, using mechanistic model 504, movement classifier 304 may determine A₁ and A₂ from B(S₂, b₂, k₂, m₁, m₂) and H(s)=A₁(s)/A₂(s). Movement classifier 304 may receive as input first sensor data from first sensor 302, which corresponds to A_{2_tot}. Movement classifier 304 may compute a likelihood that A_{2_tot} is being generated by mechanistic model 504. If the likelihood is above a threshold, that may indicate that motion of the head is overlaid with motion of the body. If the likelihood is below the threshold, that may indicate that motion of the head is isolated from motion of the body. In this manner, movement classifier 304 may distinguish from movements such as walking and nodding.

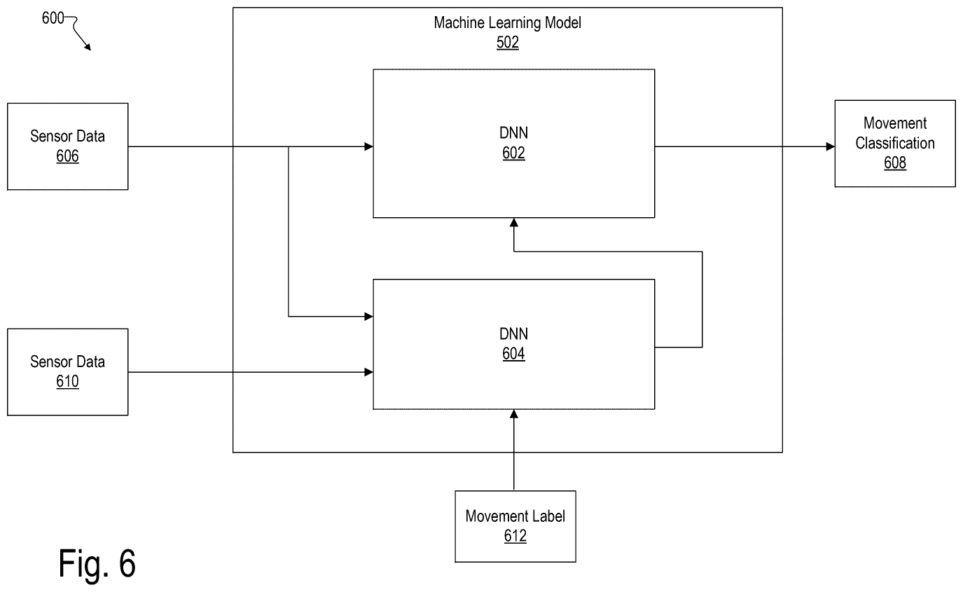

Additionally or alternatively, FIG. 6 illustrates an example configuration 600 of machine learning model 502. Configuration 600 shows machine learning model 502 including a first deep neural network (e.g., DNN 602) and a second deep neural network (e.g., DNN 604). DNN 602 may be configured to receive first sensor data 606 (e.g., sensor data from sensor 302) as input and provide a movement classification 608 as output. DNN 604 may also receive first sensor data 606 as input, as well as second sensor data 610 (e.g., additional sensor data from second sensor 404). DNN 604 may also output a movement classification, which DNN 602 may further receive as input during a training mode of DNN 602. Thus, as described, DNN 604 may use second sensor data 610 from auxiliary device 402 to provide training input for training DNN 602, such as labels for corresponding with first sensor data 606 received from sensor 302. Further, DNN 604 may optionally receive a movement label 612 as additional input, which may be “ground truth” movement and/or activity labels, as described herein.

Further, DNN 602 and/or DNN 604 (or other components of machine learning model 502 not shown) may extract relevant features from first sensor data 606 and/or second sensor data 610, such as mean, variance, and frequency domain features using techniques such as Fast Fourier Transform (FFT) or wavelet transforms.

DNN 602 and/or DNN 604 may be implemented in any suitable manner, such as including one or more convolutional neural networks (CNNs) for spatial feature extraction and/or recurrent neural networks (RNNs) for temporal sequence modeling. An input layer may be configured to accept multi-dimensional data from first sensor data 606 and second sensor data 610, as well as movement labels (e.g., output by DNN 604 and/or movement label 612) structured as a time-series sequence. An output layer may consist of softmax units corresponding to different movement and/or classes (e.g., walking, nodding, etc.).

By continuing to train machine learning model 502 and learn whenever auxiliary device 402 is detected and second sensor data 610 is available to provide additional movement classification labels, machine learning model 502 may continuously improve and learn, enhancing accuracy for determining movement classifications based on first sensor data 606 over time.

Additionally, in some examples, machine learning model 502 may be based on an initial generalized model that may be personalized as machine learning model 502 is trained using second sensor data 610. This may be implemented in any suitable manner, such as freezing initial layers of DNN 602 that capture general features and train later layers that may adapt to individual-specific features. Additionally or alternatively, a lower learning rate may be used during fine-tuning so that machine learning model 502 may adapt gradually to new data while retaining the generalized model data.

Further, in some examples, output from machine learning model 502 may be combined with mechanistic model 504 to refine movement classifications and/or predictions. For example, machine learning model 502 may provide an initial classification, which may be adjusted based on output from mechanistic model 504.

Additionally or alternatively, hearing device 202 may be configured to select between using machine learning model 502 or mechanistic model 504 to classify movements, for example, based on power conditions of hearing device 202. Such power conditions may include any suitable conditions relating to power availability and/or supply to hearing device 202, such as power on hearing device 202 running low, a battery of hearing device 202 being below a threshold charge level, hearing device 202 operating in a power-saving mode, etc. Based on such a power condition, hearing device 202 may switch from using machine learning model 502 (which may consume more power) to mechanistic model 504. Additionally or alternatively, hearing device 202 may selectively use machine learning model 502, such as for initial classifications of movements upon a detected change in a type of movement, while using mechanistic model 504 to verify movement classifications or vice versa.

In some examples, body model 306 (and/or sensor data and resulting movement classifications) may be utilized to provide additional information to user 204. For example, body model 306 (and training of body model 306) may ascertain a spinal stiffness of user 204, which may be used as a clinical proxy for various conditions, such as clinical monitoring of treatment for lower back pain, physiotherapy or medication effects, monitoring of gait and/or balance, determining fall risk, hydration monitoring, body-mass index (BMI) monitoring, or any other condition that may affect spinal stiffness.

While movement classifier 304 (and body model 306, machine learning model 502, and mechanistic model 504) have generally been depicted in the figures as being a component of hearing device 202 and the training mode may include training movement classifier 304 and/or body model 306 on hearing device 202, in some examples, training of the model may be performed on other devices and/or on a plurality of devices (e.g., as depicted in implementation 200). For example, hearing device 202 may provide training input based on auxiliary sensor data by transmitting the auxiliary sensor data to another computing device (e.g., computing device 206, auxiliary device 402, a cloud computing device, etc.) for training the model, which hearing device 202 may then access (e.g., on demand and/or download to hearing device 202). Additionally or alternatively, hearing device 202 may direct auxiliary device 402 to provide the auxiliary sensor data to the other computing device and provide sensor data from sensor 302 to train the model.

Further, in some examples, hearing device 202 may be implemented as a binaural hearing system. Thus, first sensor data 606 may include left first sensor data from a first sensor of a hearing device of the binaural system worn in the left ear and right first sensor data from a first sensor of a hearing device of the binaural system worn in the right ear, which movement classifier 304 may utilize to classify movement of user 204.

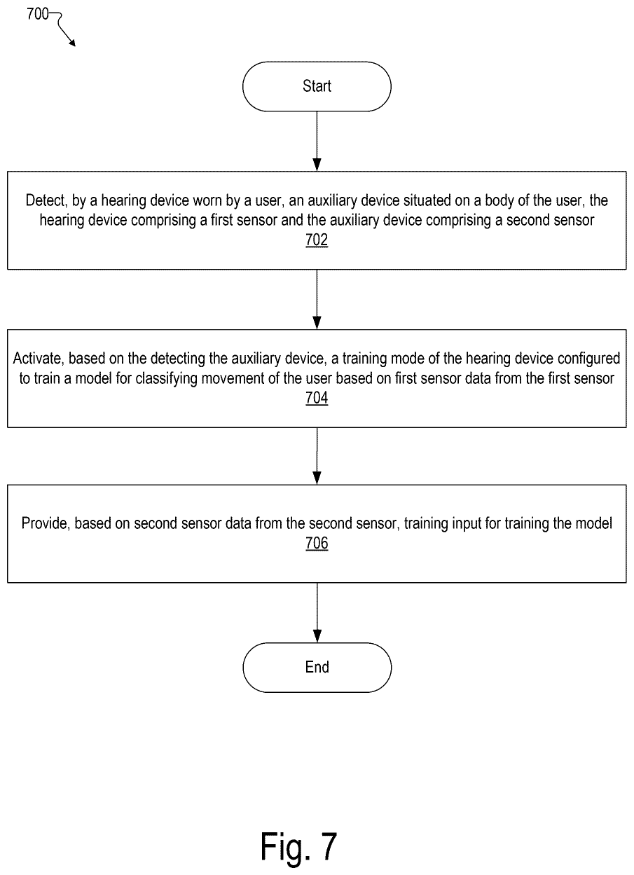

FIG. 7 illustrates an exemplary method 700 for calibrating movement classification by a hearing device according to principles described herein. While FIG. 7 illustrates exemplary operations according to one embodiment, other embodiments may omit, add to, reorder, and/or modify any of the operations shown in FIG. 7. One or more of the operations shown in FIG. 7 may be performed by a hearing device such as hearing device 202, a computing device such as computing device 206, an additional computing device communicatively coupled to computing device 206 and/or hearing device 202, any components included therein, and/or any combination or implementation thereof.

At operation 702, a hearing device worn by a user may detect an auxiliary device situated on a body of the user, the hearing device comprising a first sensor and the auxiliary device comprising a second sensor. Operation 702 may be performed in any of the ways described herein.

At operation 704, the hearing device may activate, based on the detecting the auxiliary device, a training mode of the hearing device configured to train a model for classifying movement of the user based on first sensor data from the first sensor. Operation 704 may be performed in any of the ways described herein.

At operation 706, the hearing device may provide, based on second sensor data from the second sensor, training input for training the model. Operation 706 may be performed in any of the ways described herein.

In some examples, a computer program product embodied in a non-transitory computer-readable storage medium may be provided. In such examples, the non-transitory computer-readable storage medium may store computer-readable instructions in accordance with the principles described herein. The instructions, when executed by a processor of a computing device, may direct the processor and/or computing device to perform one or more operations, including one or more of the operations described herein. Such instructions may be stored and/or transmitted using any of a variety of known computer-readable media.

A non-transitory computer-readable medium as referred to herein may include any non-transitory storage medium that participates in providing data (e.g., instructions) that may be read and/or executed by a computing device (e.g., by a processor of a computing device). For example, a non-transitory computer-readable medium may include, but is not limited to, any combination of non-volatile storage media and/or volatile storage media. Exemplary non-volatile storage media include, but are not limited to, read-only memory, flash memory, a solid-state drive, a magnetic storage device (e.g., a hard disk, a floppy disk, magnetic tape, etc.), ferroelectric random-access memory (“RAM”), and an optical disc (e.g., a compact disc, a digital video disc, a Blu-ray disc, etc.). Exemplary volatile storage media include, but are not limited to, RAM (e.g., dynamic RAM).

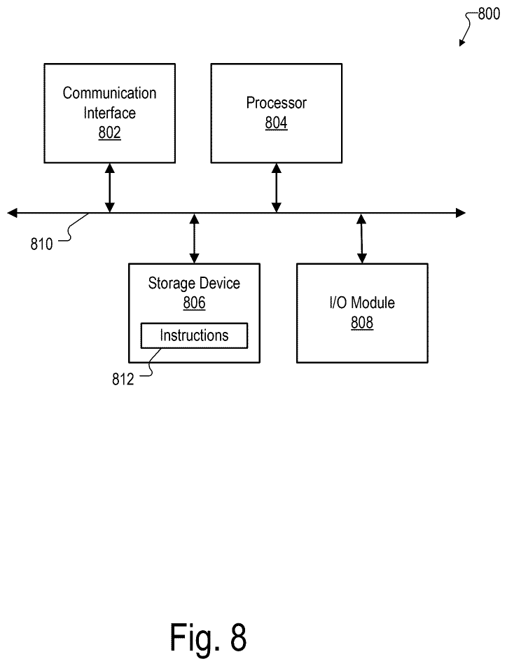

FIG. 8 illustrates an exemplary computing device 800 that may be specifically configured to perform one or more of the processes described herein. As shown in FIG. 8, computing device 800 may include a communication interface 802, a processor 804, a storage device 806, and an input/output (“I/O”) module 808 communicatively connected one to another via a communication infrastructure 810. While an exemplary computing device 800 is shown in FIG. 8, the components illustrated in FIG. 8 are not intended to be limiting. Additional or alternative components may be used in other embodiments. Components of computing device 800 shown in FIG. 8 will now be described in additional detail.

Communication interface 802 may be configured to communicate with one or more computing devices. Examples of communication interface 802 include, without limitation, a wired network interface (such as a network interface card), a wireless network interface (such as a wireless network interface card), a modem, an audio/video connection, and any other suitable interface.

Processor 804 generally represents any type or form of processing unit capable of processing data and/or interpreting, executing, and/or directing execution of one or more of the instructions, processes, and/or operations described herein. Processor 804 may perform operations by executing computer-executable instructions 812 (e.g., an application, software, code, and/or other executable data instance) stored in storage device 806.

Storage device 806 may include one or more data storage media, devices, or configurations and may employ any type, form, and combination of data storage media and/or device. For example, storage device 806 may include, but is not limited to, any combination of the non-volatile media and/or volatile media described herein. Electronic data, including data described herein, may be temporarily and/or permanently stored in storage device 806. For example, data representative of computer-executable instructions 812 configured to direct processor 804 to perform any of the operations described herein may be stored within storage device 806. In some examples, data may be arranged in one or more databases residing within storage device 806.

I/O module 808 may include one or more I/O modules configured to receive user input and provide user output. I/O module 808 may include any hardware, firmware, software, or combination thereof supportive of input and output capabilities. For example, I/O module 808 may include hardware and/or software for capturing user input, including, but not limited to, a keyboard or keypad, a touchscreen component (e.g., touchscreen display), a receiver (e.g., an RF or infrared receiver), motion sensors, and/or one or more input buttons.

I/O module 808 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 808 is configured to provide graphical data to a display for presentation to a user. The graphical data may be representative of one or more graphical user interfaces and/or any other graphical content as may serve a particular implementation.

In some examples, any of the systems, hearing devices, computing devices, and/or other components described herein may be implemented by computing device 800. For example, memory 102 and/or memory 210 may be implemented by storage device 806, and processor 104 and/or processor 212 may be implemented by processor 804.

In the preceding description, various exemplary embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

What is claimed is:

1. A method comprising:
detecting, by a processor of a hearing device worn by a user, an auxiliary device situated on a body of the user, the hearing device comprising a first sensor and the auxiliary device comprising a second sensor;
activating, by the processor based on the detecting the auxiliary device, a training mode of the hearing device configured to train a model for classifying movement of the user based on first sensor data from the first sensor; and
providing, by the processor and based on second sensor data from the second sensor, training input for training the model.

2. The method of claim 1, further comprising receiving, by the processor, the second sensor data from the auxiliary device.

3. The method of claim 2, wherein the providing the training input for training the model comprises:
determining, based on the first sensor data and the second sensor data, a classification of a movement of the user; and
providing, to the model, the classification as training input.

4. The method of claim 1, wherein the providing the training input for training the model comprises:
transmitting the first sensor data for a classification of a movement of the user based on the first sensor data and the second sensor data, the classification provided to the model as training input.

5. The method of claim 1, wherein the providing the training input for training the model further comprises providing a labeled classification of a movement of the user.

6. The method of claim 1, further comprising deactivating, by the processor based on no longer detecting the auxiliary device situated on the body of the user, the training mode.

7. The method of claim 1, further comprising:
classifying, based on first sensor data received during an application mode of the hearing device, a movement of the user; and
activating, based on the classifying, a sound processing algorithm configured to optimize sound based on the movement.

8. The method of claim 1, wherein the model comprises a machine learning algorithm.

9. The method of claim 1, wherein the model comprises a mechanistic model describing motion of a head of the user and the body of the user.

10. The method of claim 9, wherein:
the model further comprises a machine learning model; and
the method further comprises selecting, based on a power condition of the hearing device, between using the mechanistic model and the machine learning model.

11. A hearing system comprising:
a memory that stores instructions; and
a processor communicatively coupled to the memory and configured to execute the instructions to perform a process comprising:
detecting an auxiliary device situated on a body of a user of a hearing device, the hearing device comprising a first sensor and the auxiliary device comprising a second sensor;
activating, based on the detecting the auxiliary device, a training mode of the hearing device configured to train a model for classifying movement of the user based on first sensor data from the first sensor; and
providing, based on second sensor data from the second sensor, training input for training the model.

12. The system of claim 11, wherein the process further comprises receiving, by the processor, the second sensor data from the auxiliary device.

13. The system of claim 12, wherein the providing the training input for training the model comprises:
determining, based on the first sensor data and the second sensor data, a classification of a movement of the user; and
providing, to the model, the classification as training input.

14. The system of claim 11, wherein the providing the training input for training the model comprises:
transmitting the first sensor data for a classification of a movement of the user based on the first sensor data and the second sensor data, the classification provided to the model as training input.

15. The system of claim 11, wherein the providing the training input for training the model further comprises providing a labeled classification of a movement of the user.

16. The system of claim 11, wherein the process further comprises deactivating, by the processor based on no longer detecting the auxiliary device situated on the body of the user, the training mode.

17. The system of claim 11, wherein the process further comprises:
classifying, based on the first sensor data, a movement of the user; and
activating, based on the classifying, a sound processing algorithm configured to optimize sound based on the movement.

18. The system of claim 11, wherein:
the model comprises a machine learning algorithm and a mechanistic model describing motion of a head of the user and the body of the user; and
the process further comprises selecting, based on a power condition of the hearing device, between using the mechanistic model and the machine learning model.

19. A computer program product embodied in a non-transitory computer-readable storage medium and comprising computer instructions for performing a process comprising:
detecting an auxiliary device situated on a body of a user of a hearing device;
activating, based on the detecting the auxiliary device, a training mode of the hearing device configured to train a model for classifying movement of the user of the hearing device based on first sensor data from a first sensor of the hearing device; and
providing, based on second sensor data from a second sensor of the auxiliary device, training input for training the model.

20. The computer program product of claim 19, wherein the providing the training input for training the model further comprises providing a labeled classification of a movement of the user.
